(19) United States
(12) Patent Application Publication
(10) Pub. No.: US 2013/0132243 A1
(43) Pub. Date: May 23, 2013

(54) HANDLING INVOICE BASED SERVICES

(71) Applicants: Thomas Veit, Kirchheimbolanden (DE); Joachim Brechtel, Homburg/Saar (DE); Stefan Edelmann, St.Ingbert (DE); Markus Urbanek, Dortmund (DE)

(72) Inventors: Thomas Veit, Kirchheimbolanden (DE); Joachim Brechtel, Homburg/Saar (DE); Stefan Edelmann, St.Ingbert (DE); Markus Urbanek, Dortmund (DE)

(21) Appl. No.: 13/301,804

(22) Filed: Nov. 22, 2011

(51) Int. Cl. G06Q 30/04

(52) U.S. Cl. 705/30

(57) ABSTRACT

Various embodiments of systems and methods for handling invoice based services are described herein. In one aspect, the method executed by the one or more computers in a network of computers includes receiving an invoice service message related to a business process, analyzing the invoice service message, based upon the analysis, identifying a business-specific implementation, from one or more business-specific implementations, for processing the invoice service message, and executing the business-specific implementation to process the invoice service message. The automatic identification of the business-specific implementation for processing the invoice service message relieves a business partner from specifying an application-specific interface for processing the invoice service message.

### BACKGROUND

Invoice is a legal document that describes details of a transaction or consignment between sellers and buyers. Enterprises today typically handle invoices in an electronic form. Services Oriented Architecture (SOA) services may be used for handling electronic invoices. For example, the SOA services may be used for creating, modifying, cancelling, and confirming invoices. A format of the invoice may differ for different business processes or different industries. For example, the format of the invoice related to a retail industry would be different from the format of the invoice related to a power and gas industry. Usually, software applications are developed specifically for handling different types or different formats of invoices. For example, there may be a specific software application for handling the power and gas industry based invoices and another specific software application for handling the retail industry based invoices.

The applications for processing the invoices are accessed through application-specific interfaces. Typically, a vendor (e.g., service provider) provides reference of different application-specific interfaces to their business partners. A business partner may select the application-specific interface of their choice, generally, based upon the format of the invoice the business partner requires. The business partner may specify the application-specific interface in an invoice-related request to be sent to the service provider. The service provider receives the request and the request is processed through the specified application-specific interface.

However, it may be a burden on the business partner to specify the application-specific interface while sending the request. Further, it may be inconvenient for the business partner to specify the application-specific interface each time they send the request. Moreover, there is a probability of specifying a wrong application-specific interface mistakenly. Additionally, for each software application (developed for handling specific invoices) separate modules are developed for handling error, validation, and confirmation (i.e., redundant development) which may be wastage of time, effort, and resources.

### SUMMARY OF THE INVENTION

Various embodiments of systems and methods for handling invoice based services are described herein. In one aspect, a method executed by one or more computers in a network of computers includes receiving an invoice service message and analyzing the invoice service message. Based upon the analysis, a business-specific implementation is identified, from one or more business-specific implementations, for processing the invoice service message. The business-specific implementation is executed to process the invoice service message. The automatic identification of the business-specific implementation for processing the invoice service message relieves a business partner from specifying an application-specific interface for processing the invoice service message.

These and other benefits and features of embodiments of the invention will be apparent upon consideration of the following detailed description of preferred embodiments thereof, presented in connection with the following drawings.

### BRIEF DESCRIPTION OF THE DRAWINGS

The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow chart illustrating the steps performed to execute an invoice service message, according to various embodiments of the invention.

FIG. 2 is a block diagram of a system including an invoice processing framework for processing an invoice service message, according to an embodiment of the invention.

FIG. 3 is a block diagram of various business-specific implementations associated with the invoice processing framework, according to an embodiment of the invention.

FIG. 4 is a block diagram of the invoice processing framework, according to an embodiment of the invention.

FIG. 5 is a block diagram of the business-specific implementations in communication with the invoice processing framework, according to an embodiment of the invention.

FIG. 6 is a block diagram of application programming interfaces (APIs) associated with various application processing implementations, according to an embodiment of the invention.

FIG. 7 is a flow chart illustrating the steps performed by the invoice processing framework while executing the invoice service message, according to an embodiment of the invention.

FIG. 8 is a block diagram of an exemplary computer system, according to an embodiment of the invention.

### DETAILED DESCRIPTION

Embodiments of techniques for handling invoice based services are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

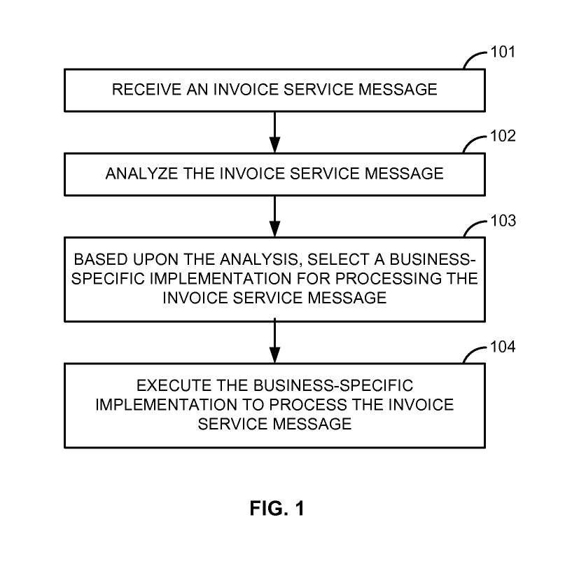

FIG. 1 is a flowchart illustrating a method for executing an invoice service message, according to one embodiment. Typically, the invoice service message is received at step 101. The invoice service message may be a request for creating, canceling, or updating an invoice. The invoice service message is analyzed at step 102. Typically, the content or configuration of the invoice service message may be analyzed. For example, the content of the invoice service message may include, e.g., a type of a business partner sending the invoice service message, one or more fields related to a business process, and a request identifier or ID indicating the services (e.g., creating, canceling, or updating the invoice, etc) requested by the business partner, etc. These contents of the invoice service message may be analyzed. Based upon the analysis, a business-specific implementation is selected for processing the invoice service message at step 103. For example, if the analysis shows that the invoice service message is related to a ‘retail industry’ then the business-specific implementation related to retail industry may be selected for processing the invoice service message. Finally, the business-specific implementation is executed to process the invoice service message at step 104. For example, the business-specific implementation related to retail industry may be executed to process the invoice service message.

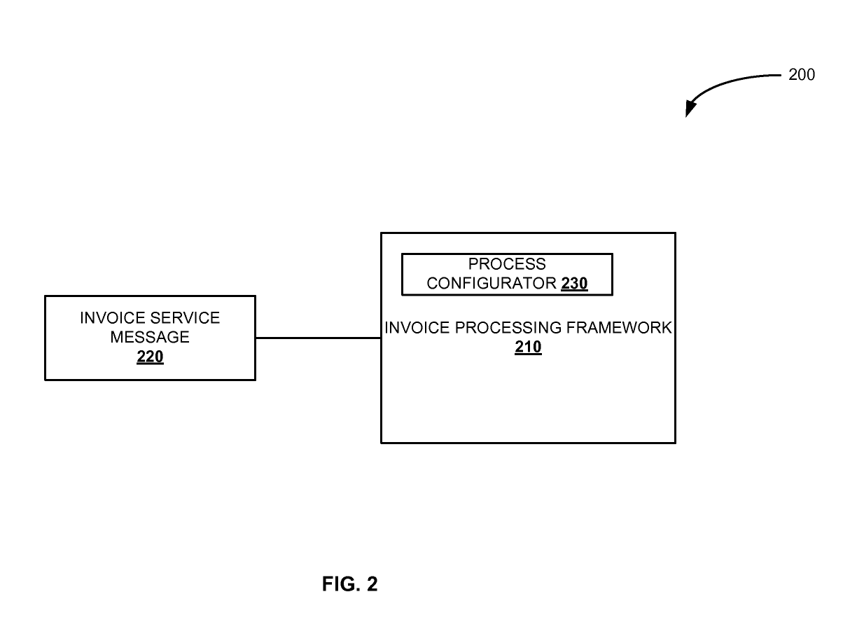

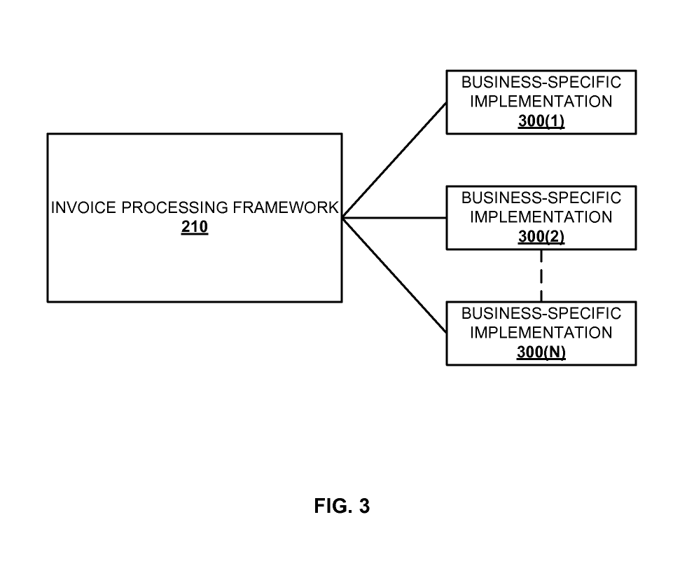

FIG. 2 illustrates one embodiment of a system 200 including an invoice processing framework 210 for processing an invoice service message 220 (e.g., according to FIG. 1). The invoice processing framework 210 includes a process configurator 230. The process configurator 230 analyzes the content of the invoice service message 220. Based upon the content of the invoice service message 220, the process configurator 230 selects a business-specific implementation (e.g., 300(2)) (shown in FIG. 3) from one or more business-specific implementations 300 (1-n) for processing the invoice service message 220. The selected business-specific implementation (e.g., 300(2)) may be called or executed by the invoice processing framework 210 to process the invoice service message 220.

The invoice service message 220 may be the request for creating, canceling, or updating the invoice. The request may be an A2A (application to application) request, e.g., request within a same company (intra-company request) or the request may be a B2B (business to business) request, e.g., request sent from one company to another (inter-company request). For example, the invoice service message 220 may be the A2A invoice create request, the A2A invoice cancel request, the A2A invoice update request, the B2B invoice update request, or the B2B invoice create request.

Once the invoice service message 220 is received, the process configurator 230 analyzes the content (e.g., configuration) of the invoice service message 220. The content of the invoice service message 220 may include, e.g., the type of the business partner sending the invoice service message, the one or more fields related to the business process, a BillToPartner field, a ProductRecipientPartner field, a BillToParty field, a BillFromParty field, a special contract or document field, and the request identifier or ID indicating the services requested by the business partner, etc. The request ID may indicate the requested services like creating, canceling, or updating an invoice, etc. The process configurator 230 analyzes the request ID and other contents of the invoice service message 220.

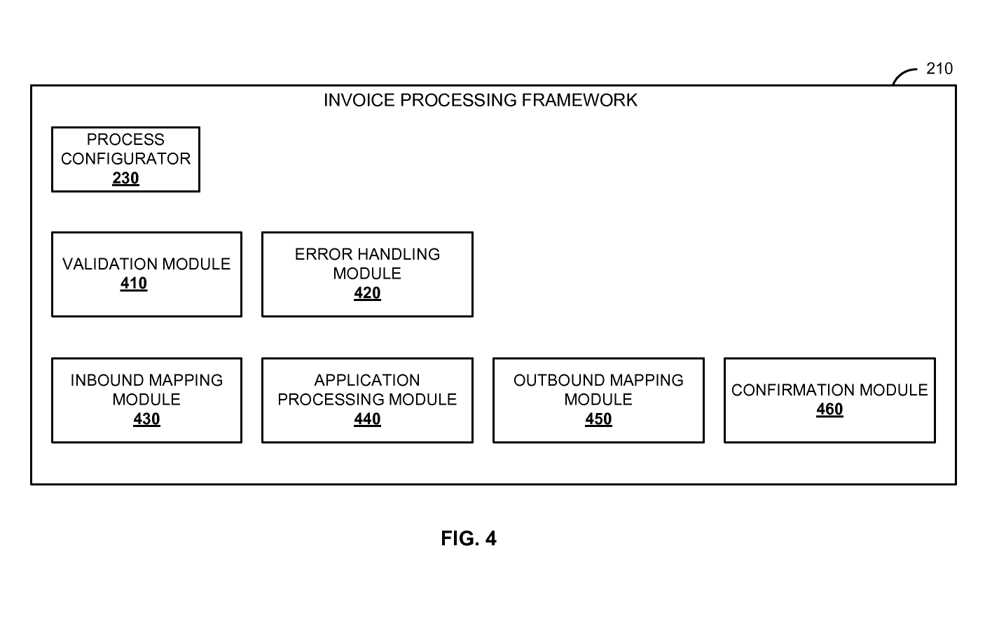

Once the invoice service message 220 is analyzed, the invoice processing framework 210 may validate the invoice service message 220. Typically, the invoice processing framework 210 includes a validation module 410 (refer to FIG. 4) to validate the invoice service message 220. If there is any error while validating the invoice service message 220, the error is handled by an error handling module 420 (refer to FIG. 4).

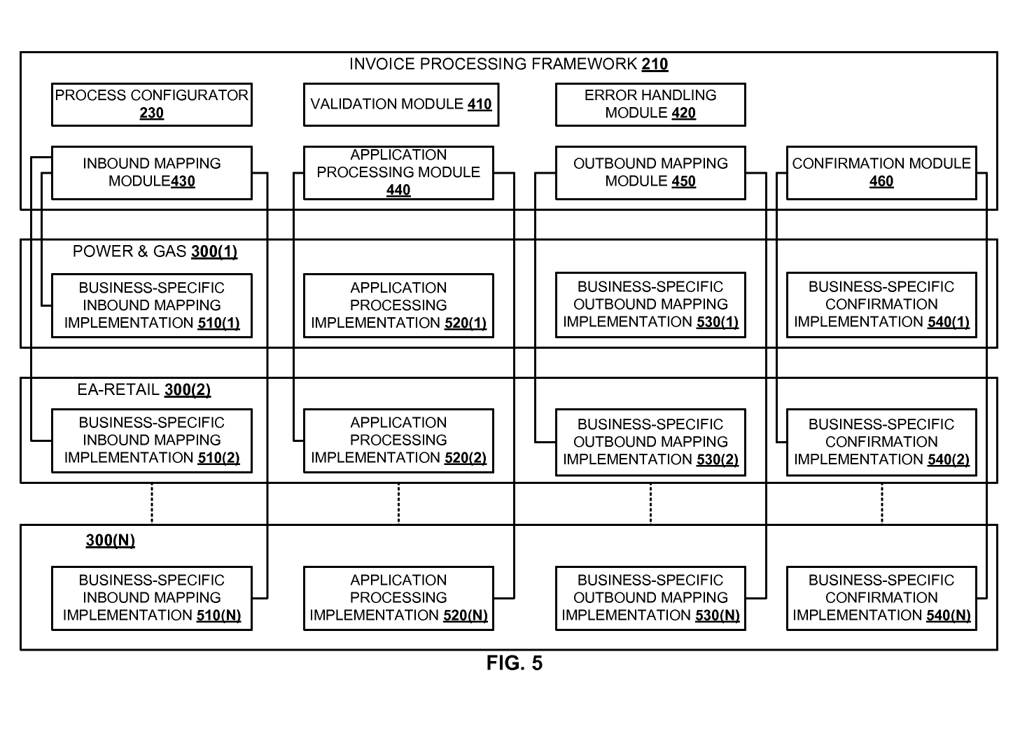

Once the invoice service message 220 is validated, the invoice service message 220 may be forwarded to an inbound mapping module 430 for performing an inbound mapping. Typically, based upon the business process (e.g., retail) of the invoice service message 220, the process configurator 230 selects a business-specific inbound mapping implementation 510(2) (in FIG. 5) related to the business process (i.e., retail). Once the business-specific inbound mapping implementation 510(2) is selected, the invoice processing framework 210 calls or executes the business-specific inbound mapping implementation 510(2) to perform inbound mapping. Typically, the invoice processing framework 210 forwards the invoice service message 220 to the inbound mapping module 430 to execute the business-specific inbound mapping implementation 510(2) for performing inbound mapping.

Typically, the inbound mapping module 430 is associated with one or more business-specific inbound mapping implementations 510 (1-n) (shown in FIG. 5) to perform inbound mapping related to various business processes. For example, the inbound mapping module 430 is associated with the business-specific inbound mapping implementation 510(2) to perform inbound mapping related to ‘retail’ based invoice service message 220. If any error occurs while performing the inbound mapping, the error may be handled by the error handling module 420.

Once the inbound mapping is performed, one or more transformed data (not shown) may be generated. The transformed data may be forwarded to an application processing module 440 (refer to FIG. 4). Typically, the application processing module 440 is associated with one or more application processing implementations 520 (1-n) (refer to FIG. 5). Each of the application processing implementation 520 (1-n) is related to a specific business process. For example, an application processing implementation 520(2) is related to the Retail (EA-RETAIL).

Typically, the process configurator 230 selects the application processing implementation 520(2) by analyzing the invoice service message 220. The selected application processing implementation 520(2) is called or executed by the invoice processing framework 210. Typically, the invoice processing framework 210 forwards the transformed data to the application processing implementation 520(2) for processing the invoice service message 220.

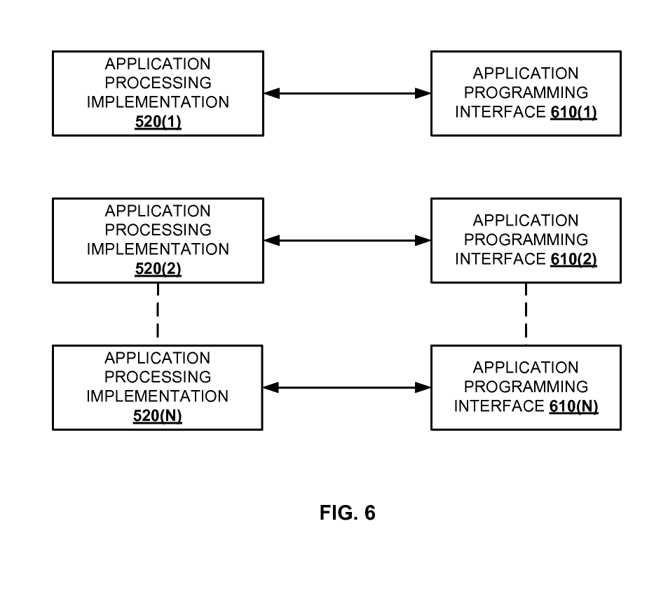

The application processing implementation 520(2) may be executed by executing one or more predefined application programming interfaces (APIs) associated with the application processing implementation 520(2). For example, the application processing implementation 520(2) may be executed by executing an API 610(2) (refer to FIG. 6) associated with the application processing implementation 520(2). Essentially, each of the application processing implementation 520(1-n) may be associated with a corresponding predefined API 610(1-n), as illustrated in FIG. 6. In one embodiment, the predefined APIs 610(1-n) may be hardcoded within each of the corresponding application processing implementations 520 (1-n). In another embodiment, there may be a control table (not shown) illustrating one or more predefined APIs 610(1-n) against each of the respective application processing implementation 520(1-n). Based upon the control table, the API 610(2) for the corresponding business specific application processing implementation 520(2) may be selected. The selected or hardcoded API 610(2) may be executed to process the transformed data of the invoice service message 220. In one embodiment, if any error occurs during execution, the error is handled by the error handling module 420. In another embodiment, the API 610(2) may be executed to generate one or more internal data (not shown). The internal data from the backend application may be returned or forwarded to the invoice processing framework 210.

Once the internal data is processed by the application processing implementation 520(2), the returned internal data may be forwarded to an outbound mapping module 450 for performing outbound mapping. The outbound mapping module 450 is associated with one or more business-specific outbound mapping implementations 530 (1-n) to perform outbound mapping related to various business processes. For example, the outbound mapping module 450 is associated with a business-specific outbound mapping implementation 530(2) to perform outbound mapping related to ‘retail’ based invoice service message 220.

Typically, the process configurator 230 selects the business-specific outbound mapping implementation 530(2) (refer to FIG. 5) for performing the outbound mapping. In one embodiment, the internal data may be transferred to the business-specific outbound mapping implementation 530(2) for performing outbound mapping. If any error occurs while performing the outbound mapping, the error may be handled by the error handling module 420.

Once the outbound mapping is performed, a confirmation message may be sent by a confirmation module 460. In one embodiment, the confirmation module 460 is associated with one or more business-specific confirmation implementations 540 (1-n) for performing confirmation related to various business processes. For example, the confirmation module 460 may be associated with a business-specific confirmation implementation 540(2) to perform confirmation related to ‘retail’ based invoice service message 220. In one embodiment, the process configurator 230 selects a business-specific confirmation implementation 540(2) (refer to FIG. 5) related to the invoice service message 220. In another embodiment, the confirmation module 460 sends different confirmation message based upon the invoice service message 220. For example, the confirmation module 460 may send different confirmation message for A2A invoice service message and B2B invoice service message.

In one embodiment, if it is analyzed that the ‘BillToPartner’ field and the ‘ProductRecipientPartner’ field of the invoice service message 220 is the same then the invoice processing framework 210 may call or execute a standard invoice implementation (not shown) for processing the invoice service message 220. Typically, the standard invoice implementation process the invoice service message 220 meant for standard invoices.

Each of the business-specific implementations 300(1-n) includes their respective business specific inbound mapping implementations 510(1-n), application processing implementations 520(1-n), outbound mapping implementations 530(1-n), and confirmation implementations 540(1-n), as illustrated in FIG. 5. Referring to the above embodiments, the validation module 410 and the error handling module 420 may be common or generic modules for all the business-specific implementations 300 (1-n), as illustrated in FIG. 5.

In one embodiment, a new business-specific implementation (not shown) may be defined for a new business process. The new business-specific implementation may be integrated with the invoice processing framework 210. The new business-specific implementation may include a new business-specific inbound mapping implementation (not shown), a new business-specific outbound mapping implementation (not shown), a new application processing implementation, and a new business-specific confirmation implementation. The new business-specific inbound mapping implementation and the new business-specific outbound mapping implementation may be integrated with the corresponding inbound mapping module 430 and the outbound mapping module 450. Similarly, the new application processing implementation and the new business-specific confirmation implementation may be integrated with the corresponding application processing module 440 and the confirmation module 460.

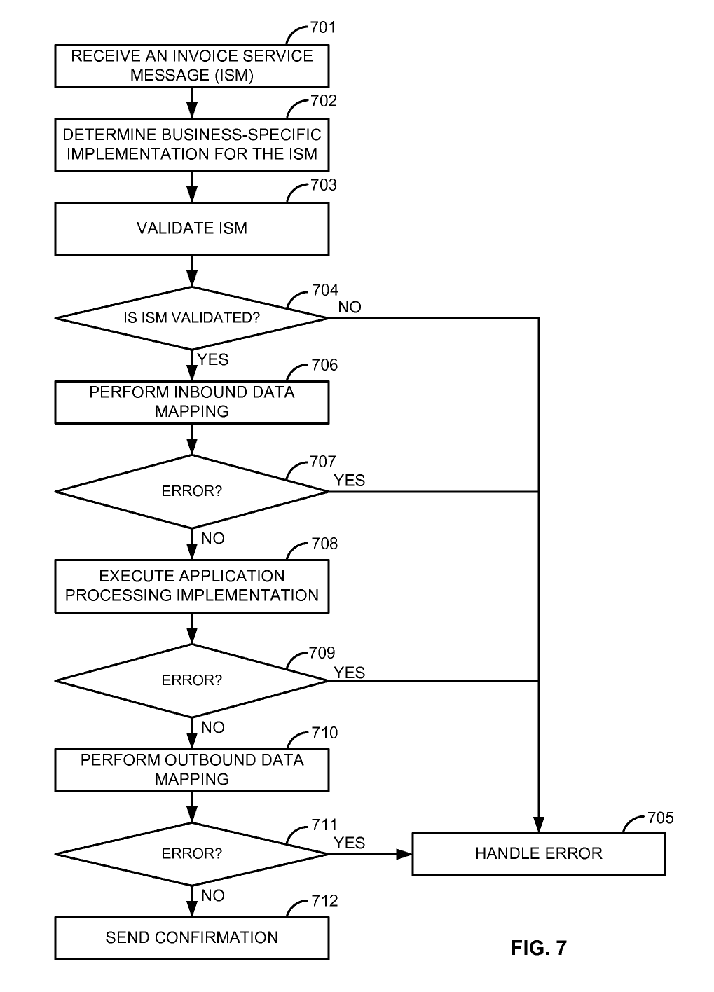

FIG. 7 is a flowchart illustrating various steps performed by the invoice processing framework 210 while processing the invoice service message 220. Typically, the invoice processing framework 210 receives the invoice service message 220 at step 701. The received invoice service message 220 is analyzed by the process configurator 230. The process configurator 230 determines the business-specific implementation (e.g., 300(2)) for the invoice service message 220 at step 702. Once the business-specific implementation 300(2) is determined, the invoice processing framework 210 validates the invoice service message at step 703. If the invoice service message 220 is not validated (step 704: NO), the error handling module 420 is activated to handle the error at step 705. In case the invoice service message 220 is validated (step 704: YES), the invoice service message 220 is forwarded to the inbound mapping module 430 for performing inbound mapping at step 706. While performing inbound mapping, it is determined if any error is occurred at step 707. If the error is occurred (step 707: YES) the error is handled by the error handling module 420 at step 705. In case the inbound mapping is performed successfully (step 707: NO) the resulting transformed data is forwarded to the application processing module 440. Typically, the process configurator 230 selects the application processing implementation 520(2) to process the invoice service message 220. Typically, the application processing implementation 520(2) is executed to process the transformed data at step 708. While processing the invoice service message 220 it is determined if any error is occurred at step 709. If the error is occurred (step 709: YES) the error is handled by the error handling module 420 at step 705. In case the error is not occurred (step 709: NO) the returned internal data from the application processing implementation 520(2) is forwarded to the outbound mapping module 450 to perform outbound mapping at step 710. It is determined if any error occurred while performing the outbound mapping at step 711. In case the error occurred while performing the outbound mapping (step 711: YES), the error handling module 420 handles the error at step 705. In case the outbound mapping is performed successfully and there is no error (step 711: NO) the confirmation message is sent to the sender at step 712.

The embodiments enable an automatic selection of the business-specific implementation for processing the invoice service message. Therefore, the business parties may be relieved from the burden of identifying and providing an application-specific interface for processing their invoice service messages. Further, various business-specific processing/implementation provides an efficient mechanism for handling various formats of invoices for different business processes. Additionally, common or generic modules for handling error and validation related to various business processes obviates redundant development and saves resources, time, and effort of the service provider. Moreover, the business-specific functionalities (e.g., inbound mapping, outbound mapping, and invoice processing, etc) and general functionalities (e.g., validation and error handling, etc) provide a standardized structure based upon SOA implementations guidelines.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

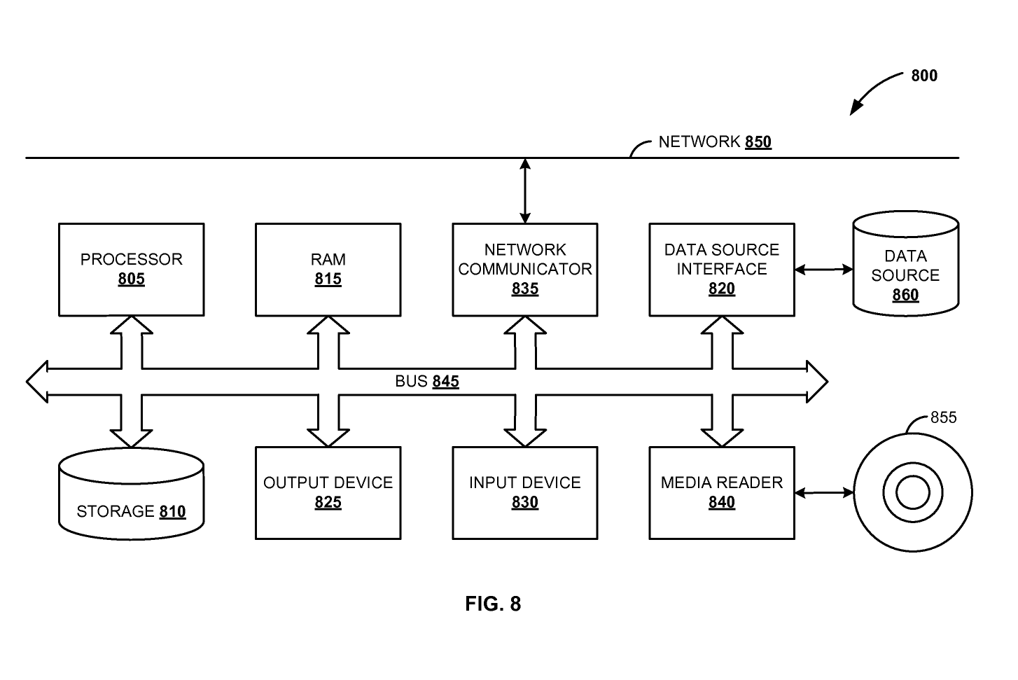

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by one or more computers in a network of computers causes the performance of the following operation:
the one or more computers receiving an invoice service message related to a business process;
the one or more computers analyzing the invoice service message;
based upon the analysis, the one or more computers identifying a business-specific implementation, from one or more business-specific implementations, for processing the invoice service message; and
the one or more computers executing the business-specific implementation to process the invoice service message.

2. The article of manufacture of claim 1, wherein the invoice service message includes at least one of the following:
a type of a business partner sending the invoice service message; and
a service request identifier indicating at least one of the following services requested by the business partner:
creating one or more invoices;
canceling the one or more invoices;
reading the one or more invoices; and
updating the one or more invoices.

3. The article of manufacture of claim 1, wherein the business-specific implementation is a standard invoice implementation and wherein the standard invoice implementation is associated with one or more standard invoices.

4. The article of manufacture of claim 1, wherein the one or more business-specific implementations are defined for corresponding one or more business processes.

5. The article of manufacture of claim 1, wherein each of the one or more business-specific implementations includes:
a business-specific inbound mapping implementation for performing inbound mapping on the invoice service message;
a business-specific outbound mapping implementation for performing outbound mapping on the invoice service message; and
an application processing implementation for processing the invoice service message.

6. The article of manufacture of claim 5 further comprising instructions which when executed cause the one or more computers to:
identify the business process related to the invoice service message;
based upon the identified business process, determine the application processing implementation for processing the invoice service message; and
execute the application processing implementation to:
select one or more application programming interfaces (APIs) associated with the application processing implementation; and
execute the selected one or more APIs.

7. The article of manufacture of claim 5, wherein each of the business-specific implementation is controlled by an invoice processing framework.

8. The article of manufacture of claim 7 further comprising instructions which when executed cause the one or more computers to:
identify a new business-specific implementation defined for a new business process; and
integrate the new business-specific implementation with the invoice processing framework.

9. The article of manufacture of claim 7, wherein the invoice processing framework includes at least one of the following:
a confirmation module;
a validation module;
an error handling module;
an inbound mapping module;
an outbound mapping module; and
an application processing module.

10. The article of manufacture of claim 9, wherein the inbound mapping module is associated with one or more business-specific inbound mapping implementations included within the corresponding one or more business-specific implementations and the outbound mapping module is associated with one or more business-specific outbound mapping implementations included within the corresponding one or more business-specific implementations.

11. The article of manufacture of claim 10 further comprising instructions which when executed cause the one or more computers to perform at least one of the following:
identify the business process related to the invoice service message;
based upon the identified business process, determine at least one of the business-specific inbound mapping implementation and the business-specific outbound mapping implementation for performing the inbound mapping and the outbound mapping, respectively, on the invoice service message.

12. The article of manufacture of claim 9, wherein the confirmation module is associated with one or more business-specific confirmation implementations included within the respective business-specific implementation.

13. A method for handling invoice related services implemented on a network of one or more computers, the method comprising:
the one or more computers receiving an invoice service message related to a business process;
the one or more computers analyzing the invoice service message;
based upon the analysis, the one or more computers identifying a business-specific implementation, from one or more business-specific implementations, for processing the invoice service message; and
the one or more computers executing the business-specific implementation to process the invoice service message.

14. The method of claim 13, wherein the one or more business-specific implementations are related to corresponding one or more specific business processes and wherein each of the business-specific implementation includes an application processing implementation for processing the invoice service message.

15. The method of claim 14 further comprising:
the one or more computers identifying the business process related to the invoice service message;
based upon the identified business process, the one or more computers determining the application processing implementation for processing the invoice service message; and
the one or more computers executing the application processing implementation to:
select one or more application programming interfaces (APIs) associated with the application processing implementation; and
execute the selected one or more APIs.

16. The method of claim 14, wherein each of the business-specific implementation is controlled by an invoice processing.

17. The method of claim 16 further comprising:
the one or more computers identifying a new business-specific implementation defined for a new business process; and
the one or more computers integrating the new business-specific implementation with the invoice processing framework.

18. The method of claim 13 further comprising at least one of the followings:
the one or more computers identifying the business process related to the invoice service message; and
based upon the identified business process, the one or more computers determining a business-specific inbound mapping implementation and a business-specific outbound mapping implementation for performing an inbound mapping and an outbound mapping, respectively, on the invoice service message.

19. A computer system for handling invoice based services, comprising:
a memory to store program code; and
a processor communicatively coupled to the memory, the processor configured to execute the program code to cause one or more computers in a network of computers to:
receive an invoice service message related to a business process;
analyze the invoice service message;
based upon the analysis, identify a business-specific implementation, from one or more business-specific implementations, for processing the invoice service message; and
execute the business-specific implementation to process the invoice service message.

20. The computer system of claim 19, wherein the processor is further configured to perform at least one of the following:
identify the business process related to the invoice service message;
based upon the identified business process, determine an application processing implementation associated with the business-specific implementation; and
execute the application processing implementation to process the invoice service message.
